(19) United States
(12) Patent Application Publication
(10) Pub. No.: US 2025/0061126 A1
(43) Pub. Date: Feb. 20, 2025

(54) Processor, Computer Program Product, System and Method for Data Transformation

(71) Applicant: Siemens Aktiengesellschaft, München (DE)

(72) Inventors: Swathi Shyam Sunder, Bengaluru (IN); Tobias Aigner, München (DE); Janaki Joshi, Vaterstetten (DE)

(73) Assignee: Siemens Aktiengesellschaft, München (DE)

(21) Appl. No.: 18/721,484

(22) PCT Filed: Dec. 14, 2022
(86) PCT No.: PCT/EP2022/085869

§ 371 Date: Jun. 18, 2024

(30) Foreign Application Priority Data
Dec. 21, 2021 (IN) 202111059812

(51) Int. Cl. G06F 16/25

(52) U.S. Cl. CPC G06F 16/254

(57) ABSTRACT

The teachings of the present disclosure relates to data transformation from source data in RDB format to result data in RDF format. Various embodiments of these teachings make source data from e.g., sensors and/or monitoring devices machine readable by transforming datasets in RDB format to datasets in graph dataset format as RDF datasets are.

### CROSS-REFERENCE TO RELATED APPLICATIONS

This application is a U.S. National Stage Application of International Application No. PCT/EP2022/085869 filed Dec. 14, 2022, which designates the United States of America, and claims priority to IN Application No. 202111059812 filed Dec. 21, 2021, the contents of which are hereby incorporated by reference in their entirety.

### TECHNICAL FIELD

The present disclosure relates to data transformation. Various embodiments of the teachings herein include processors, computer programs, systems, and/or method for transforming data from source data in RDB format to result data in RDF format.

### BACKGROUND

In an industrial scenario, data may be generated during each phase of a product's lifecycle. The data thus generated may be associated with, for example, planning, design, manufacturing, processing, operation and/or maintenance of the product. Each of the phases correspond to a specific domain and are associated with different forms of structured data. The structured data are thus the source data and may be stored in different relational databases, so called “RDBs”.

For production of so called “digital twins” for process plants (e.g., industrial/power/oil and gas plants) it is usual to drive activities such as plant monitoring & optimization, plant maintenance & optimization, plant modernization, and comparison of plants. All these activities create so called “source data” in different formats, e.g., formats as Excel, CSV, XML, JSON data.

The sources refer to databases like MySQL™, PostgreSQL(R)™, MSSQL™ and files. Creating plant digital twins may be more efficient via knowledge graphs, based on Resource Description Framework “RDF” databases as “source data”, based on RDBs from a lot of different formats and sources needs to be integrated in RDFs to succeed.

The process of creating the RDF database for a knowledge graph from RDB source data is depicted in a general overview in FIG. 1, showing state of the art. Conventionally, integrating the structured RDB-format source data corresponding to different domains and/or formats involves the use of ETL “Extract, Transform, Load” processes for mapping the structured data to RDF data especially by an ontology of a knowledge graph.

FIG. 1 shows a high-level explanatory overview of a prior art ETL workflow to produce a knowledge graph from source data. In the first step source data 1 is generated and loaded from the data source 1, for example a device for plant monitoring and/or sensor, camera to check product quality. Example of data sources include industrial plant(s), an industrial production line(s), traffic, energy, air and/or light observation within a crowded city respective part of a city, meteorological data, data of electrical current flow, data of geographical plant(s) and/or data of parts of a plant like data of pumps, motors, valves, vessels which are obtained during different operational phases of production or manufacturing in an industrial plant. Usually, data are generated by data generation devices such as monitoring devices and/or sensors.

These source data 1 may refer to planning, managing, configuring and/or controlling of—for example—a production line. The collection of these source data 1 may optionally be subjected to any necessary pre-processing 2. Independently of the preprocessing, an ontology 3 is developed and/or imported for the domain corresponding to the source data 1 being considered. Additionally, mappings 4 from the source data 1 to the ontology are also designed and/or selected.

This is followed by execution of the mappings 5 on the source data 1 to generate a graph 7. This processing step 5 is the core during the knowledge graph 7 creation through an ETL workflow from source data 1. Between the core mapping rule execution step 5 and the knowledge graph 7 creation there may be optionally a postprocessing step 6 being executed.

For example, source data as e.g., plant data, can be in Excel XML, JSON, MSQL or CSV files. Microsoft® Excel enables users to format, organize and calculate data in a spreadsheet. A “CSV”—Comma-separated values—file is a delimited text file that uses a comma to separate values. Each line of the file is data record. Each record consists of one or more fields, separated by commas. The use of the comma as a field separator is the source of the name for this file format. XML files “Extendible Markup Language” is a markup language that defines a set of rules for encoding documents in a format that is both human-readable and machine-readable. The World Wide Web Consortium's XML 1.0 specification of 1998 and several other related specifications—all of them free open standards—define XML.

JSON is an open standard file format and data interchange format that uses human-readable text to store and transmit data objects consisting of attribute-value pairs and arrays. It is a common data format with diverse uses in electronic data interchange, including that of web applications with servers.

Source data of industrial real environment are available in many relational formats and from many devices, serving as sources. Usually, source data is stored in different relational databases (RDB). However, integrations such heterogenous formats and sources is a difficult task. Knowledge graphs (KGs) are suitable and commonly used solution for data integration. So, source data from different source formats can be mapped to graph schemas, formally referred to as ontologies.

A knowledge graph “KG” is a knowledge base that uses a graph-structured data model or topology to integrate data. A knowledge graph is—for example—used to store interlinked descriptions of entities—objects, events, situations, monitoring data of plants, production lines etc. Data stored in a knowledge graph are suitable to be processed by artificial intelligence, cloud applications, other applications and/or automated controls. World Wide Web becomes more and more machine readable. Technologies like RDF and OWL are used to make WWW machine readable.

RDF “Resource Description Framework” is a family of World Wide Web Consortium specifications originally designed as a data model for metadata. RDF is a standard model for data interchange on the Web. RDF extends the linking structure of the Web to use URIs to name the relationship between things as well as the two ends of the link—this is usually referred to as a “triple”.

URI “Uniform Resource Identifier” is a unique sequence of characters that identifies a logical or physical resource used by web technologies. URIs may be used to identify anything, including real-world objects, such as peoples, places, concepts, information resources such as web pages and/or books. Some URIs provide a means of locating and retrieving information resources on a network (either on the Internet or on another private network, such as a computer filesystem or an Intranet); these are Uniform Resource Locators (URLs). A URL provides the location of the resource. A URI identifies the resource by name at the specified location or URL. URIs are used to identify anything described using RDF, for example, concepts that are part of an ontology defined using the Web Ontology Language “OWL”.

The Internationalized Resource Identifier “IRI” is an internet protocol standard which builds on the Uniform Resource Identifier URI protocol by greatly expanding the set of permitted characters. It was defined by the Internet Engineering Task Force. For example, besides the characters used by URI, IRI comprises also Chinese, Japanese, Korean and Cyrillic characters.

“R2RML” mapping defines a mapping from a relational database to RDF. It is a structure that consists of one or more triples maps. The input to a R2RML mapping is called the input database and contents the source data. A R2RML processor is a system that, given a R2RML mapping and an input database, provides access to the output dataset being RDF.

W3C “World Wide Web Consortium” is an international community where Member organizations, a full-time staff, and the public work together to develop open standards to ensure the long-term growth of the Web.

“Turtle” Terse RDF Triple Language is a syntax and file format for expressing data in the RDF data model. Turtle syntax is like that of SPARQL and RDF query language. It is a common data format for storing RDF data.

“RDFLib”, “RDF-Library” is a python library for working with RDF, a simple yet powerful language for representing information. This library contains parsers/serializers for almost all the known RDF serializations, such as RDF/XML, Turtle, N-Triples, Json-LD, many of which are now supported in their updated form.

“Blazegraph® is an ultra-high-performance graph database “DB” supporting blueprints and RDF/SPARQLAPIs. It supports up to 50 billion edges on a single machine.

To map data from relational databases to RDF a standard model for representation of semantic data (or KGs), a widely used W3C standard that is commonly used is the R2RML specification. R2RML specifies how the data is mapped to RDF with at least one R2RML text mapping file. R2RML mappings themselves as result are RDF graphs and can be serialized in Turtle format.

The mapping execution, to produce RDF triples as result data from the RDB source data, is done with a R2RML processor. It can read the relational source data, transform it into the target RDF format as per a text parser of the R2RML text mapping files and store the resulting RDF into a text file or a graph database. There are several implementations available for such processors in both open source and commercial variants. The available solutions, typically, work with a text-based approach to parse and transform the data.

As these text-based approaches of the state of the art can be error-prone, it is object of the present invention to improve the method for R2RML processing by text parser systems.

The R2RML specification provides a general approach for generating RDF triples from the mappings, as described in the W3C recommendation 27 Sep. 2012. This document describes R2RML, a language for expressing customized mappings from relational databases to RDF datasets. Such mappings provide the ability to view existing relational data in the RDF data model, expressed in a structure and target vocabulary of the mapping author's choice. R2RML mappings are themselves RDF graphs and written down in Turtle syntax. R2RML enables different types of mapping implementations.

For the described algorithm, it is important to note that the relational data (relevant data corresponding to the queries within the mappings) and triples map(s) are prerequisites. There is no guideline as to how these should be generated. The approach for deriving these components from the mapping file(s) is left to the discretion of the R2RML processor implementation.

The existing processors use text parsing on the R2RML text mapping files only to extract the aforementioned components. Given the specification prescribed by the standard, one can assume certain structure (with respect to the order of constructs, delimiters, etc.) to be followed by the mapping file and therefore, the text parsing approach (e.g., using rules, regular expressions) can be expected to work. However, this approach suffers from several drawbacks, most crucial of which are listed below.

Since the standard also allows for some flexibility (in terms of order of components, associations across and among components, etc.), ensuring completeness and correctness while extracting the components requires numerous cases to be handled in text parsing, thereby making it a tedious task.

This kind of text parsing may not even be able to guarantee that the outputs are properly tokenized.

Moreover, the processor would also have to handle various exceptions for when the R2RML text mapping file is erroneous (e.g., contains syntactic inconsistencies) and not all errors can be expected upfront.

Unless the R2RML text mapping file has issues at the beginning or end of file, in which case either the file read results in an error or the text parsing fails, it may be hard to validate the mappings, e.g., checking individual queries or rules, whether they are structured properly.

### SUMMARY

Teachings of the present disclosure may improve and amend the methods for processing of R2RML text mapping files so that is not solely based on text parsing to overcome the mentioned drawbacks.

This may help make source data from e.g., sensors and/or monitoring devices machine readable by transforming datasets in RDB format to datasets in graph dataset format as RDF datasets are. For example, some embodiments of the teachings of the present disclosure include a processor for generating RDF dataset(s) from RDB source data by R2RML text file mappings characterized in that the processor in configured to extract from at least one graph structure by a mapping query within the R2RML mapping process at least one triple map for the RDF dataset.

In some embodiments, the processor contains at least one storage unit configurated to store intermediate R2RML mappings as a graph.

In some embodiments, the processor is configured to execute SPARQL queries as part of its workflow.

As another example, some embodiments include a computer implemented method for producing a graph dataset from source data in RDB format by R2RML mapping, comprising the following operations performed by one or more processor units: a) store suitable R2RML text mapping file (s) in a first memory unit; b) reading of at least one R2RML text mapping file; c) text parsing of the R2RML text mapping file; d) receiving, by one or more of physical data generation device(s), source data as RDBs; d) store source data in a third memory unit; e) optionally preprocessing of the source data; f) storing of mapping SPARQL queries to second memory unit; g) extracting by SPARQL query all prefixes and namespaces of R2RML text mapping file; h) extracting of triple map(s) from the R2RML text mapping file; i) for each triples map extracted in step h),
ia—extract logical table name or SQL query, ib—extract subject IRI template and subject class, ic—extract all predicates and associated objects; j) run SQL queries extracted under ia) against the underlying database to fetch relevant data; and k) transform source data into result data and thereby generate graph database and/or RDF file(s) by R2RML specification.

In some embodiments, source data are generated in an industrial environment.

In some embodiments, the source data are generated in an urban environment.

In some embodiments, the result data are used to train an artificial intelligence.

In some embodiments, the result data are transferred to a cloud application.

As another example, some embodiments include a system for transformation of relational source data into result data suitable to build up a knowledge graph the system being executed by R2RML mapping rule execution, the system comprising: several recording devices, monitoring devices and/or sensors to generate source data; and at least one R2RML processor with several processing and memory units communicatively coupled as follows: at least one first memory unit that stores suitable mapping file(s), at least one second memory unit that stores mapping queries, at least one third memory unit that stores source data; whereby the at least first memory unit is communicatively coupled to a first processing unit, the first processing unit reading the mapping file(s) and being communicatively coupled to a second processing unit executing the R2RML text parser, the second processing unit being communicatively coupled to a third processing unit executing the mapping by exploiting the well-defined graph structure of the R2RML mappings, the third processing unit being communicatively coupled to get input from the second processing unit and the at least one second memory unit and the at least one third memory unit; and the third processing unit being communicatively coupled to transfer the resulting data to the at least one fourth memory unit that stores the result data as graph database or RDF file.

In some embodiments, the fourth memory unit is communicatively coupled to an artificial intelligence.

As another example, some embodiments include a computer program product comprising a processor as described herein, characterized in that it has as input source data in relational format and as output result data which are machine readable and suitable to train an artificial intelligence.

As another example, some embodiments include a computer implemented use of SPARQL queries in combination with R2RML text mapping files to transform RDB source data into RDF result data.

### BRIEF DESCRIPTION OF THE DRAWINGS

Hereinafter, embodiments for carrying out the present invention are described in detail. The various embodiments are described with reference to the drawings, wherein like reference numerals are used to refer to like elements throughout. In the following description, for purpose of explanation, numerous specific details are set forth in order to provide a thorough understanding of one or more embodiments. It may be evident that such embodiments may be practiced without these specific details.

FIG. 1 a high-level explanatory overview of a prior art ETL workflow to produce a knowledge graph from source data; and

FIG. 2 illustrates a system 100 incorporating teachings of the present disclosure and comprising a processor for R2RML text mapping file transformation;

FIG. 3 shows a sample R2RML text mapping file that can be used to convert data from RDB to RDF incorporating teachings of the present disclosure;

FIG. 4 shows an example of R2RML mappings with a well-defined structure incorporating teachings of the present disclosure;

FIG. 5 shows an example of a generic SPARQL query to extract logical table(s) from R2RML mappings incorporating teachings of the present disclosure;

FIG. 6 shows another example of a generic SPARQL query to extract logical table(s) from R2RML mappings incorporating teachings of the present disclosure; and

FIG. 7 shows an example workflow incorporating teachings of the present disclosure for a graph-based R2RML processor.

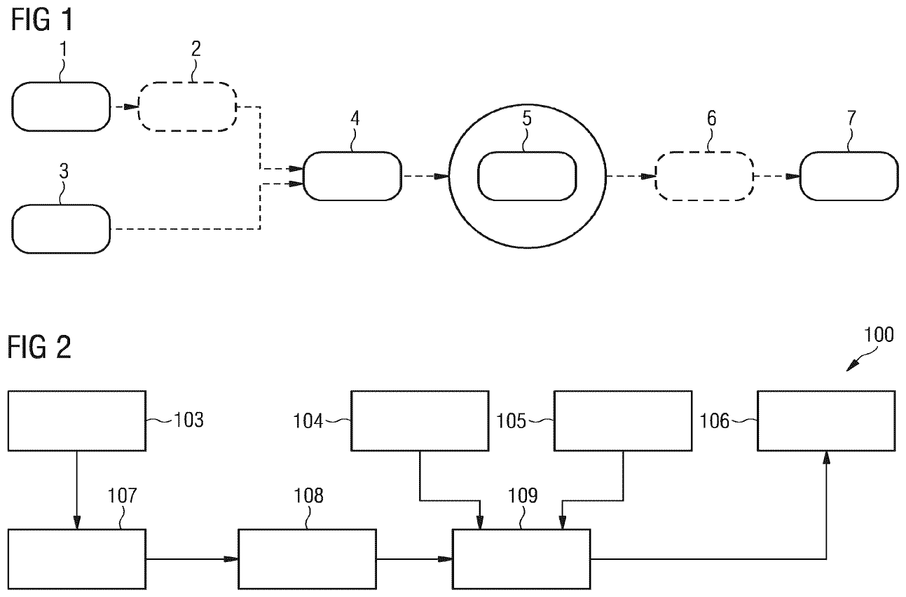

### DETAILED DESCRIPTION

Various embodiments of the teachings herein include processors, methods and/or systems for mapping of source data being stored in one or more RDB storage units into graph datasets of RDF-data stored in storage unit of a graph database(s), especially knowledge graph database(s) as described herein. Some embodiments include the computer-implemented use of SPARQL queries in combination with R2RML text mapping files.

A computer program product may be, for example, a computer program or comprise another element apart from the computer program. This other element may be hardware, for example a memory device, on which the computer program is stored, a hardware key for using the computer program and the like, and/or software, for example a documentation or a software key for using the computer program.

Some embodiments include a processor for generating RDF dataset(s) from RDB source data by R2RML mappings characterized in that the processor extracts by a given query from at least one graph structure within the R2RML mapping at least one triple map for the RDF dataset.

The teachings herein may be used to take state of the art R2RML text mapping and use SPARQL queries to extract from state-of-the-art R2RML text mapping files a structure similar to the triple-structure of the RDF datasets and thereby rendering the transformation of any relational dataset being the source data to graph-datasets being the result data much more reliable.

As an example, some embodiments include a system for transformation of relational source data into result data suitable to build up a knowledge graph, the system comprising: several devices, monitoring devices and/or sensors to generate source data as RDB data; at least one R2RML processor with a number of processing and memory units communicatively coupled as follows: at least one first memory unit that stores suitable R2RML text mapping file(s); at least one second memory unit that stores mapping SPARQL queries; at least one third memory unit that stores source data; whereby the at least first memory unit is communicatively coupled to a first processing unit, the first processing unit reading the mapping file(s) and being communicatively coupled to a second processing unit executing the R2RML text parser; the second processing unit being communicatively coupled to a third processing unit executing the mapping by exploiting the well-defined graph structure of the R2RML text mapping files; the third processing unit being communicatively coupled to get input from: the second processing unit and the at least one second memory unit and the at least one third memory unit; and the third processing unit being communicatively coupled to transfer the resulting data to the at least one fourth memory unit that stores the result data as a graph database and/or RDF file(s).

As another example, some embodiments include a method for computer implemented data transformation, the method comprising: transforming source data from physical devices such as monitoring devices, sensors, controlling devices, etc. these source data being available as RDBs into result data in RDF by R2RML mapping, comprising the following operations performed by one or more processor units: a) receiving, by one or more of physical data generation device, source data as RDBs; b) store source data in a third memory unit; c) optionally preprocessing of the source data; d) store suitable R2RML text mapping file in a first memory unit; d) reading of at least one R2RML text mapping file; e) text parsing of the R2RML text mapping file; f) storing of mapping SPARQL queries to second memory unit; g) extracting by SPARQL query all prefixes and namespaces of R2RML text mapping file; h) extracting of triple map(s) from the R2RML text mapping file; i) for each triples map extracted in step h), ia—extract logical table name or SQL query, ib—extract subject IRI template and subject class, ic—extract all predicates and associated objects; j) —run SQL queries extracted under ia) against the underlying database to fetch relevant data; and k) transform source data into result data and thereby generate graph database and/or RDF file(s) by R2RML specification.

Unless indicated otherwise in the description below, the terms “map”, “execute”, “extract” “read”, “store”, “parse”, “generate”, “configure”, “reconstruct” and the like preferably relate to actions and/or processes and/or processing steps that alter and/or produce data and/or that convert data into other data, the data being able to be presented or available as physical variables, in particular, for example as electrical impulses. In particular, the expression “computer”, “processing unit” and/or “processor” should be interpreted as broadly as possible in order to cover in particular all electronic devices having data processing properties. Computers can therefore be for example personal computers, servers, programmable logic controllers (PLCs), handheld computer systems, Pocket PC devices, mobile radios and other communication devices that can process data in computer-aided fashion, processors, and other electronic devices for data processing.

MySQL™ is an open-source relational database management system (RDBMS). Its name is a combination of “My” and “SQL”, the abbreviation for “Structured Query Language”. SQL is a programming language, more exactly a domain-specific language used in programming and designed for managing data held in a relational database management system, or for stream processing in a relational data stream management system.

“PostgreSQL”, also known as Postgres, is a free and open-source relational database management system emphasizing extensibility and SQL compliance. It was originally named POSTGRES, referring to its origins as a successor to the Ingres database developed at the University of California.

MSSQL® is the Microsoft® SQL Server. This is a relational database management system developed by Microsoft®. As a database server, it is a software product with the primary function of storing and retrieving data as requested by other software applications—which may run either on the same computer or on another computer across a network.

FIG. 2 illustrates a block diagram of an example system comprising a R2RML processor incorporating teachings of the present disclosure.

“RML” stands for “RDF Mapping Language”. RML is a generic mapping language, based on and extending R2RML. The RDF Mapping language (RML) is a mapping language defined to express customized mapping rules from heterogenous data structures and serializations to the RDF data model. RML is defined as a superset of the W3C-standardized mapping language R2RML, aiming to extend its applicability and broaden its scope, adding support for data in other structured formats. R2RML is the W3C standard to express customized mappings from relational databases to RDF. RML follows exactly the same syntax as R2RML, therefore, RML mappings are themselves RDF graphs.

Hereinafter, embodiments for carrying out the present invention are described in detail. The various embodiments are described with reference to the drawings, wherein like reference numerals are used to refer to like elements throughout. In the following description, for purpose of explanation, numerous specific details are set forth in order to provide a thorough understanding of one or more embodiments. It may be evident that such embodiments may be practiced without these specific details.

FIG. 2 illustrates an example system 100 incorporating teachings of the present disclosure and comprising a processor for R2RML text mapping file transformation, comprising several memory units 103, 104, 105, 106 and several processing units 107, 108 and 109.

For transformation via R2RML text file mapping process there is a first memory unit 103 with R2RML text mapping files stored therein. This memory unit 103 is communicatively coupled to a first processing unit 107, which is configured to read the R2RML text mapping files and to transfer the reading to a second processing unit 108. Thus, processing unit 107 is communicatively coupled to a processing unit 108 containing a text parser system. Processing unit 108 is configured to parse the R2RML text mapping and is communicatively coupled to a third processing unit 109. Within third processing unit 109 the output of second processing unit 108, mapping queries as stored in the second memory unit 104 and—last but not least—source data as stored within memory unit 105 are assembled to generate out of data belonging to the R2RML text mapping file and data belonging to source data graph data that are stored in the fourth memory unit 106 as result data in RDF format.

The above-mentioned attributes, features, and advantages of the teachings of the present disclosure and the manner of achieving them, will become more apparent and understandable (clear) with the following description of example embodiments in conjunction with the corresponding drawings. The illustrated embodiments are intended to illustrate, but not limit the scope of the disclosure.

R2RML specifies how the data is mapped to RDF with at least one R2RML text mapping file, as stored in the at least one first memory unit. Generally, R2RML text mapping file(s) contain rules that are dependent on the source data and therefore will change with change of source data as stored in the third memory unit. R2RML mappings themselves are RDF graphs and can be serialized in Turtle format.

### Example 1 Table 1 Relational Source Data from a RDB Table “PeopleInfo”

| Name¤ | Role¤ | ¤ |
|---|---|---|
| John·Doe¤ | Student¤ | ¤ |
| Jane·Doe¤ | Employee¤ | ¤ |

Relational Data with Corresponding RDF Triples as Result Data Table 2 (Fourth Memory Unit)

| Name | Role | Triples |
|---|---|---|
| John Doe | Student | <http://some/graph/Person#John_Doe> |
| | | <http://some/graph/hasRole> |
| | | <http://some/graph/Role#Student> |
| Jane Doe | Employee | <http://some/graph/Person#Jane_Doe> |
| | | <http://some/graph/hasRole> |
| | | <http://some/graph/Role#Employee> |

The two tables above show example data from a relational database table along with their corresponding equivalents in RDF.

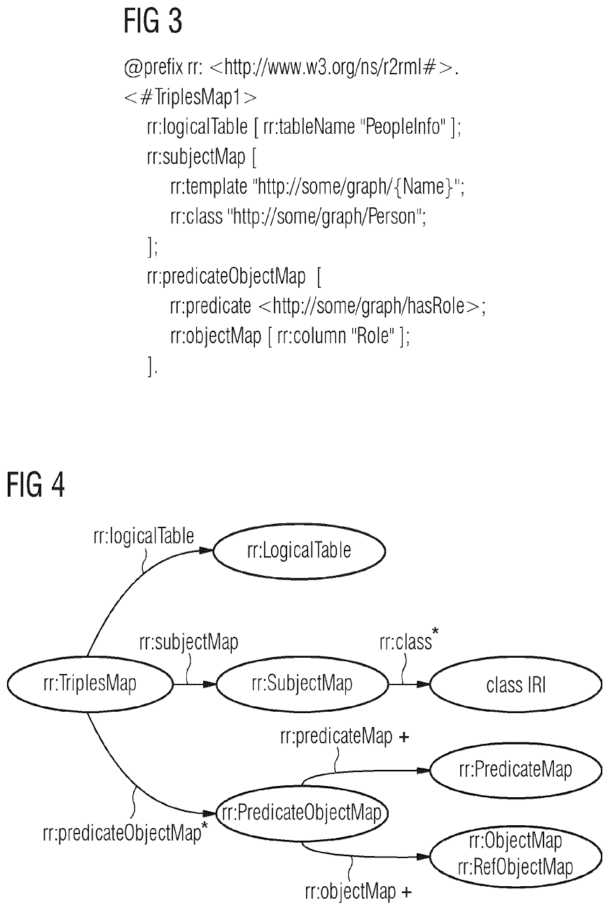

A sample R2RML text mapping file that can be used to convert data from RDB to RDF is shown in FIG. 3.

As shown in FIG. 3 the R2RML text mapping file defines which column(s) from the relational table serve as the subject(s) and their association to other data columns through data or object properties. The mappings may be defined directly on the logical table or on a view of the table generated using a SQL query.

The mapping execution to produce RDF triples from the RDB data, is then done with a R2RML processor. As state of the art, the R2RML processor can read the relational source data, transform it into the target RDF format as per the R2RML text mapping files and store the resulting RDF into a file or a graph database.

The R2RML mappings adhere to a well-defined structure as partly demonstrated in FIG. 4. Any triple map is comprised of three components
logical table
subject map
predicate-object-map.

The R2RML processor must deconstruct the mapping to extract the different components like the subject, its associated properties and objects, table name or table view and then map them onto the tabular data.

Teachings of the present disclosure may be used to exploit this well-defined graph structure of the R2RML mappings e.g., as stored in the first memory unit 103 of FIG. 2 and build a robust R2RML processor. The mapping graph, being the result of the third processing unit 109, can either be stored in in-memory stores, graph databases and/or RDF files, like “RDFLib” or persistent triple stores, like Blazegraph®.

To get the transformation of data more reliable and effective, once the mappings are available in a triple store—see third processing unit 109 of FIG. 2—it is possible to access them via SPARQL queries. The proposed R2RML third processing unit for mapping execution engine traverses the entities and relations in the R2RML text mapping file to extract the triples map components and sub-components. As part of the R2RML processing according to one aspect of the invention it is proposed to execute multiple SPARQL queries to traverse the graph and extract the different components. The generic nature of these queries—the queries are independent of the source data—not only serves to exploit the graph structure inherent in the mappings but also ensures that any mapping which conforms to the R2RML standard can be executed successfully, regardless of the domain.

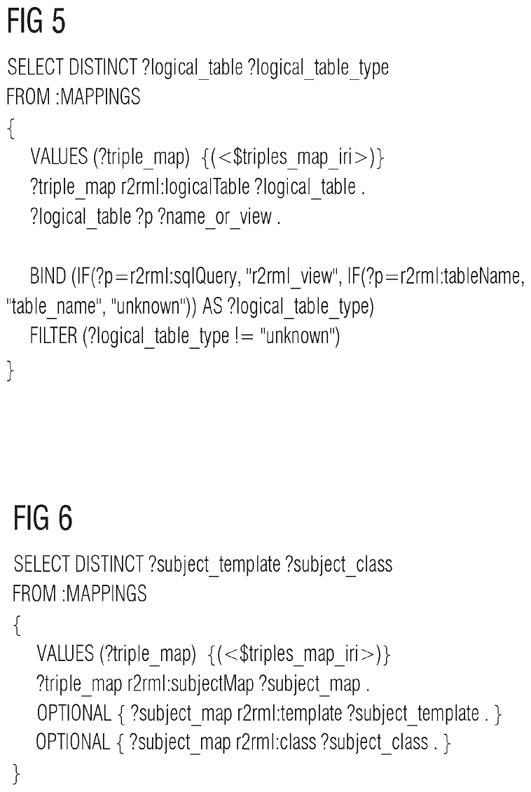

FIG. 5 shows an example of a generic SPARQL query to extract logical table(s) from R2RML mappings as an example according to one embodiment of the invention. A result of executing e.g., SPARQL, query from FIG. 5 on mapping of FIG. 3 is the table 3 below:

TABLE 3

| logical_table | logical_table_type |
|---|---|
| PeopleInfo | table_name |

FIG. 6 shows another example of a generic SPARQL query to extract logical table(s) from R2RML mappings as another example according to a second embodiment of the invention. A result of executing SPARQL query from FIG. 6 on mapping of FIG. 3 is the table 4 below:

TABLE 4

| subject_template | subject_class |
|---|---|
| http://some/graph/{Name} | <http://some/graph//Person> |

Based on the results of such generic SPARQL queries, all necessary components from the mappings can be extracted. Using them, the R2RML processor can generate the expected RDF triples. More specifically, using the results from tables 3 and 4 above, a processor according to another embodiment of the present invention can produce the triples—as resultant RDF triples after processing data from tables 3 and 4 shown as table 5:

TABLE 5
Triples

| | |
|---|---|
| <http://some/graph/Person#John Doe> | rdf: type |
| <http://some/graph/Person> | |
| <http://some/graph/Person#Jane Doe> | rdf: type |
| <http://some/graph/Person> | |

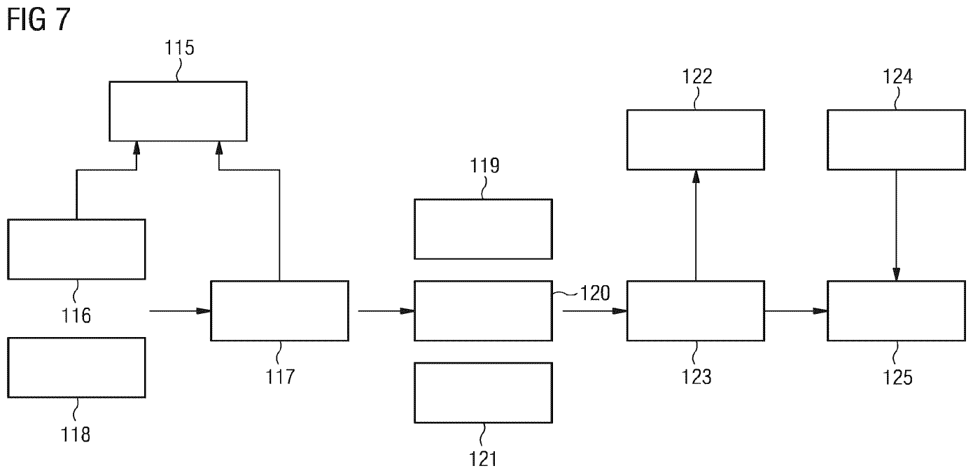

Continuing in a similar fashion, according to another aspect of the invention it is proposed to use SPARQL queries to extract other parts of the R2RML text mapping file and map them to the underlying data. FIG. 7 shows an example workflow incorporating teachings of the present disclosure for a graph-based R2RML processor. As shown in FIG. 7:
1. Extract all prefixes 116 and namespaces 118 of the R2RML text mapping file 115
2. Extract triples map(s) 117 from the R2RML text mapping file
3. For each triples map extracted in step 2 above 117
   3.1. Extract logical table name or SQL query 119
   3.2. Extract subject IRI template and subject class 120
   3.3. Extract all predicates and associated objects 121
4. Run SQL queries 123 extracted at step 3.1 against the underlying database 122—assumed that the database configuration details, such as security features are available, to fetch relevant data 122.

Thereafter, to generate the RDF triples for knowledge graph 124, one can refer to the known algorithm prescribed by the known R2RML specification 125.

In comparison to typical solutions, a combined text-based and graph-based approach for processing and execution of R2RML mappings incorporating teachings of the present disclosure may offer several advantages, as listed below:
1. Better and cleaner implementation avoiding excessive conditional checks to handle all cases as in the text-based parsing
2. Robustness as opposed to using text extraction methods
3. Capability to handle valid mappings regardless of the order in which they are specified
4. Serves as a tool to validate the mapping rules, i.e., if the mapping file isn't properly formed or contains errors, either loading it into a graph would already fail or query execution later would fail.
5. Combination of known standard query SPARQL query together with R2RML text mapping files

If it is known that in a particular R2RML processor, the mappings are stored/accessed as a graph, e.g., in some intermediate storage, this might be a potential indication. If a particular R2RML processor executes SPARQL queries as part of its workflow, this might be a potential indication. This disclosure describes a new approach to R2RML mapping by using the graph structure of the mapping text subject them to SQARL queries and thereby obtain a R2RML mapping of source data in graph structure for easier transformation into RDF format.

What is claimed is:

1. A processor for generating RDF dataset(s) from RDB source data by R2RML text file mappings, the processor programmed to: extract from at least one graph structure by a mapping query within the R2RML mapping process at least one triple map for the RDF dataset.

2. A processor as claimed in claim 1, the processor including at least one storage unit configurated to store intermediate R2RML mappings as a graph.

3. A processor as claimed in claim 1, the processor configured to execute SPARQL queries as part of its workflow.

4. A method for producing a graph dataset from source data in RDB format by R2RML mapping, the method comprising:
a) storing suitable R2RML text mapping file(s) in a first memory unit;
b) reading at least one R2RML text mapping file;
c) parsing text of the R2RML text mapping file;
d) receiving, from physical data generation device(s), source data as RDBs;
d) storing source data in a third memory unit;
e) preprocessing the source data;
f) storing mapped SPARQL queries to second memory unit;
g) extracting by SPARQL query all prefixes and namespaces of the R2RML text mapping file;
h) extracting triple map(s) from the R2RML text mapping file;
i) for each triples map extracted in h),
ia) —extracting a logical table name or a SQL query,
ib) —extracting subject IRI template and subject class, and
ic) —extracting all predicates and associated objects;
j) running SQL queries extracted under ia) against the underlying database to fetch relevant data; and
k) transforming source data into result data and thereby generating graph database and/or RDF file(s) by R2RML specification.

5. The method according to claim 4, wherein the source data represent an industrial environment.

6. The method according to claim 4, wherein the source data represent an urban environment.

7. The method according to claim 4, further comprising using the result data to train an artificial intelligence.

8. The method according to claim 4, further comprising transferring the result data to a cloud application.

9. A system for transformation of relational source data into result data suitable to build up a knowledge graph the system being executed by R2RML mapping rule execution, the system comprising:
several recording devices, monitoring devices and/or sensors to generate source data; and
a R2RML processor;
a first memory unit storing mapping file (s);
a second memory unit storing mapping queries;
a third memory unit storing source data;
wherein the first memory unit is communicatively coupled to a first processing unit reading the mapping file(s) and communicatively coupled to a second processing unit executing the R2RML text parser;
the second processing unit communicatively coupled to a
third processing unit executing the mapping by exploiting the well-defined graph structure of the R2RML mappings,
the third processing unit communicatively coupled to
the second processing unit and
the second memory unit and
the third memory unit,
the third processing unit communicatively coupled to transfer the resulting data to the a fourth memory unit storing the result data as graph database or RDF file.

10. The system according to claim 9 wherein the fourth memory unit is communicatively coupled to an artificial intelligence.

11-12. (canceled)
